(19) United States
(12) Patent Application Publication
(10) Pub. No.: US 2026/0356408 A1
(43) Pub. Date: Nov. 12, 2026

(54) ANIMAL WASTE COLLECTION CART

(71) Applicant: Timothy Brown, Lees Summit, MO (US)

(72) Inventor: Timothy Brown, Lees Summit, MO (US)

(21) Appl. No.: 19/202,317

(22) Filed: May 8, 2025

(51) Int. Cl. B62B 1/26; B62B 1/14; B62B 5/06; B65F 1/14; E01H 1/12

(52) U.S. Cl. CPC B62B 1/264; B62B 1/14; B62B 5/06; B65F 1/1473; B62B 2202/03; B65F 2240/136; E01H 1/1206

(57) ABSTRACT

An animal waste collection cart, including a bin holder, a handle assembly, including a handle, and an adjustable pole extending perpendicularly from the handle, a main body, including a main pole coupled to the adjustable pole, a first auxiliary support pole connected to the main pole at a first end of the first auxiliary support pole extending outwardly away from the main pole, a second auxiliary support pole connected to the main pole at a first end of the second auxiliary support pole extending outwardly away from the main pole, a first curved pole connected to a second end of the first auxiliary support pole, a second curved pole connected to a second end of the second auxiliary support pole, an axle connected to a second end of the first curved pole and a second end of the second curved pole, and wheels connected to the axle.

### BACKGROUND

### 1. Field

The present general inventive concept relates generally to a cart, and particularly, to an animal waste collection cart.

### 2. Description of the Related Art

Pets, such as dogs, often need to be “walked” by their owners when the pets need to relieve themselves.

When a dog excretes fecal matter in public, the owner must pick up the fecal matter in order to be compliant with the law.

However, after the feces are picked up by the owner with a plastic bag, for example, it is inconvenient and somewhat nauseating to keep the fecal-filled bag in the owner's pocket, until a trash can is located.

Therefore, there is a need for a device that facilitates the fecal pick-up and storage process.

### SUMMARY

The present general inventive concept provides an animal waste collection cart.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an animal waste collection cart pushable by a user, the animal waste collection cart including a bin holder having a round shape and configured to hold a bin therein, a handle assembly, including a handle grippable by the user, and an adjustable pole to extend perpendicularly from the handle, a main body, including a main pole configured to slidably couple to the adjustable pole, a first auxiliary support pole disposed at a bottom portion of the main pole at a first end of the first auxiliary support pole and configured to extend outwardly away from the main pole, a second auxiliary support pole disposed at the bottom portion of the main pole at a first end of the second auxiliary support pole and configured to extend outwardly away from the main pole, a first curved pole connected to a second end of the first auxiliary support pole, such that a first end of the curved pole is connected to a first side of the bin holder, a second curved pole connected to a second end of the second auxiliary support pole, such that a first end of the curved pole is connected to a second side of the bin holder, an axle connected to a second end of the first curved pole at a first end of the axle, and connected to a second end of the second curved pole at a second end of the axle, a first wheel disposed at the first end of the axle, and a second wheel disposed at the second end of the axle.

The animal waste collection cart may further include a bin configured to store animal waste therein and configured to be removably disposed within the bin holder.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a side angled perspective view of an animal waste collection cart, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### List of Components

Trash Bag Container 10
Trash Bags 11
Poop Scooper 20
Animal Waste Collection Cart 100
Main Body 110
Main Pole 111
Locking Pin 111a
First Auxiliary Support Pole 112
Second Auxiliary Support Pole 113
First Curved Pole 114
Second Curved Pole 115
Curved Pole Support Pole 116
Brake Pole 117
Brake Pole Foot 118
Trash Bag Container Holder 119
Bin Holder 120
Axle 130
First Wheel 140
Second Wheel 150
Bin 160
Bin Lid 161
Bin Lid Handle 162
First Bag Holding Knob 163
Second Bag Holding Knob 164
Screened Base 165
Handle Assembly 170
Adjustable Pole171
Locking Pin Apertures 172
Handle 173
Poop Scooper Holders 180

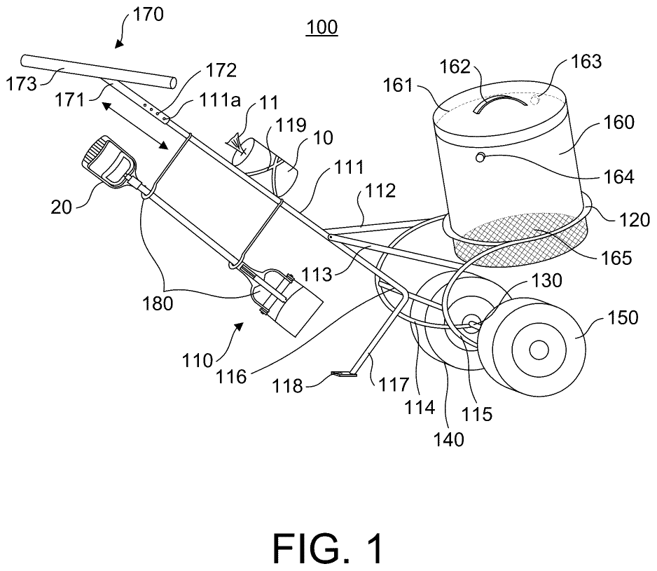

FIG. 1 illustrates a side angled perspective view of an animal waste collection cart 100, according to an exemplary embodiment of the present general inventive concept.

The animal waste collection cart 100, and all components therein, may be constructed from at least one of wood, plastic, paper, metal, silicone, liquid, fibers, threads, fabric, foam, sponge, nylon, vinyl, feathers, glass, adhesives, circuitry, and rubber, etc., but is not limited thereto, and can be constructed from any material known to one of ordinary skill in the art.

The animal waste collection cart 100 may include a main body 110, a bin holder 120, an axle 130, a first wheel 140, a second wheel 150, a bin 160, a handle assembly 170, and a plurality of poop scooper holders 180, but is not limited thereto.

The main body 110 may include a series of poles connected together at various portions, and may include a main pole 111, a locking pin 111a, a first auxiliary support pole 112, a second auxiliary support pole 113, a first curved pole 114, a second curved pole 115, a curved pole support pole 116, a brake pole 117, a brake pole foot 118, and a trash bag container holder 119, but is not limited thereto.

The main pole 111 may include the locking pin 111a disposed at a first end of the main pole 111.

The trash bag container holder 119 may be disposed on the main pole 111, and may be configured to hold a trash bag container 10 therein. The trash bag container 10 may include plastic bags 11 disposed therein.

The brake pole 117 may extend downward and outward and substantially perpendicularly from bottom end of the main pole 111, and may include a brake pole foot 118 disposed at an end portion of the brake pole 117 that may contact a floor when a user desires to set the animal waste collection cart 100 in a stationary position.

The first auxiliary support pole 112 and the second auxiliary support pole 113 may be connected to the main pole 111 at first ends thereof, and may spread outwardly therefrom in a “V” formation.

The first curved pole 114 and the second curved pole 115 may be connected to second ends of the first auxiliary support pole 112 and the second auxiliary support pole 113, respectively. The curved pole support pole 116 may connect the first curved pole 114 to the second curved pole 115.

The bin holder 120 may be disposed at first ends of the first curved pole 114 and the second curved pole 115, and may be circular in shape to allow the bin 160 (i.e., a cylindrical bin) to be held thereinside. In other words, the bin holder 120 may be an extension of the main body 110 that has a circular shape.

The axle 130 may be disposed at second ends of the first curved pole 114 and the second curved pole 115, such that the second ends of the first curved pole 114 and the second curved pole 115 are connected via the axle 130.

The first wheel 140 may be disposed at a first end of the axle 130, and the second wheel 150 may be disposed at a second end of the axle 130. As such, the axle 130 may allow the first wheel 140 and the second wheel 150 to spin when the animal waste collection cart 100 is pushed by a user.

The bin 160 may be a cylindrical bin that may be held by the bin holder 120, and may include a bin lid 161, a bin lid handle 162, a first bag holding knob 163, a second bag holding knob 164, and a screened base 165, but is not limited thereto.

The bin 160 may be configured to store animal waste therein, such as animal waste disposed within the plastic bags 11. The bin lid 161 may be removably disposed at a top portion of the bin 160, and may be a cover for the bin 160 that is removable by a user picking up the bin lid 161 via the bin lid handle 162, which may be disposed on a top surface of the bin lid 160.

The first bag holding knob 163 and the second bag holding knob 164 may be small metallic knob-like protrusions disposed at side portions of the bin 160, and may allow a user to connect on of the plastic bags 11 thereto, so that the plastic bag 11 is secured to an inside portion of the bin 160 and held in place via the first bag holding knob 163 and the second bag holding knob 164.

The screened base 165 may be provided at a bottom portion of the bin 160, and may be any type of porous screen known to one of ordinary skill in the art. The screened base 165 may allow a user to easily clean out the bin 160 due to the porous configuration of the screen base 165.

The handle assembly 170 may include an adjustable pole 171, a plurality of locking pin apertures 172, and a handle 173, but is not limited thereto.′

The adjustable pole 171 may be configured to receive the main pole 111 therein. Specifically, the adjustable pole 171 may be adjustable with respect to the main pole 111, such that an end portion of the main pole 111 is slidably disposed within the adjustable pole 171. Thus, the adjustable pole 171 may slide up and down an end portion of the main pole 111, thereby allowing a combination of the main pole 111 and the adjustable pole 171 to have an overall variable length.

The plurality of locking pin apertures 172 may be disposed through the adjustable pole 171, and may be configured to receive the locking pin 111a therein to allow the adjustable pole 171 to be locked in place when a desired length of the combination of the main pole 111 and the adjustable pole 171 is achieved.

The handle 173 may be disposed at an end point of the adjustable pole 171, and may allow a user to easily maneuver the animal waste collection cart 100.

The plurality of poop scooper holders 180 may include hooks attached to the main pole 111, which are configured to hold a poop scooper 20.

The present general inventive concept may include an animal waste collection cart 100 pushable by a user, the animal waste collection cart 100 including a bin holder 120 having a round shape and configured to hold a bin 160 therein, a handle assembly 170, including a handle 173 grippable by the user, and an adjustable pole 171 to extend perpendicularly from the handle 173, a main body 110, including a main pole 111 configured to slidably couple to the adjustable pole 171, a first auxiliary support pole 112 disposed at a bottom portion of the main pole 111 at a first end of the first auxiliary support pole 112 and configured to extend outwardly away from the main pole 111, a second auxiliary support pole 113 disposed at the bottom portion of the main pole 111 at a first end of the second auxiliary support pole 113 and configured to extend outwardly away from the main pole 111, a first curved pole 114 connected to a second end of the first auxiliary support pole 112, such that a first end of the curved pole 114 is connected to a first side of the bin holder 120, a second curved pole 115 connected to a second end of the second auxiliary support pole 113, such that a first end of the curved pole 115 is connected to a second side of the bin holder 120, an axle 130 connected to a second end of the first curved pole 114 at a first end of the axle 130, and connected to a second end of the second curved pole 115 at a second end of the axle 130, a first wheel 140 disposed at the first end of the axle 130, and a second wheel 150 disposed at the second end of the axle 130.

The animal waste collection cart 100 may further include a bin 160 configured to store animal waste therein, and may be removably disposed within the bin holder 120.

The present general inventive concept is designed to offer an easy, hygienic, and efficient way to collect and dispose of pet waste, particularly dog feces, in both indoor and outdoor spaces. It provides a hands-free collection system, allowing pet owners and businesses like dog kennels, daycares, and play areas to quickly and safely clean up waste with minimal contact. This system makes the entire cleanup process faster and more convenient, ensuring a cleaner environment for both pets and their owners.

The present general inventive concept includes several key components that contribute to its functionality. The plastic or metal Trash Bin serves as the central component where users place a plastic or biodegradable bag to collect waste. The bag is securely fastened using hooks, ensuring it stays in place throughout the cleaning process. The heavy duty wheels make the cart easy to maneuver across different terrains, from rough outdoor surfaces like grass, dirt, and gravel to smooth indoor floors, providing flexibility for various environments. The brake/balance Leg ensures that the cart remains stable when stationary, preventing it from tipping over while users take breaks or prepare for the next round of cleanup.

To keep the waste collection process organized, the hooks for the poop scooper store the scooping tool, making it easily accessible without the need to carry it by hand. The plastic bags holder ensures that extra bags are readily available, allowing users to quickly replace full bags during larger cleanup sessions without interruption. The handle with rubber grip offers an ergonomic design that reduces hand strain and provides a secure grip while pushing the cart, with the flexibility of changing the height to accommodate different people. The side knobs to hold plastic bag prevent the bag from slipping or shifting during use, ensuring that waste is collected efficiently. Finally, the grated bottom/hole design makes cleaning the cart easy, preventing moisture buildup and reducing odor and bacterial growth.

The present general inventive concept addresses several common problems related to pet waste collection. One of the main issues it solves is the need for direct contact with waste, which can be unpleasant and unhygienic. The cart's hands-free collection system ensures that users do not have to handle the waste directly, making the process much cleaner. It also solves the problem of frequent bag changes during larger cleanup sessions. With the Plastic Bag Holder, users always have extra bags within reach, allowing for quick replacements without interrupting their cleanup task.

Navigating rough terrain, like grass and gravel, can be difficult with traditional carts, but the heavy duty wheels ensure that the present general inventive concept moves smoothly across various surfaces, indoors or outdoors. The brake/balance leg prevents the cart from tipping over when stationary, offering stability and security while users take breaks or prepare for the next task. Additionally, the cart's design helps users stay organized, with hooks for the poop scooper and extra bag storage that reduces clutter and keeps everything accessible.

The grated bottom/hole design also helps reduce odor and bacteria buildup, making it easier to maintain a clean cart after each use. Beyond waste collection, the present general inventive concept offers added versatility. As a push spreader, it can also be used for applying lawn seed, turf treatments, or ice melt products, reducing the need for extra equipment and saving valuable storage space.

In summary, the present general inventive concept is a highly functional and practical solution for pet waste collection in both indoor and outdoor environments. It provides a hands-free system, easy maneuverability, and organization features that address common problems like direct contact with waste, navigating rough terrain, frequent bag changes, and tool storage. Its added functionality as a push spreader makes it an even more valuable tool for homeowners and businesses, offering an efficient way to maintain clean spaces while minimizing waste cleanup efforts.

The present general inventive concepts unique due to its combination of hands-free waste collection, easy maneuverability across both outdoor and indoor environments, and built-in organization for cleanup tools and bags. With features like heavy-duty wheels for navigating rough terrain, a brake for stability when stationary, and hooks to store the poop scooper and extra bags, the cart offers a highly efficient and hygienic solution to pet waste management. Additionally, its versatility as a push spreader for lawn treatments and ice melt makes it an all-in-one tool that saves both time and storage space, addressing a range of needs for pet owners, businesses, and homeowners.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A animal waste collection cart pushable by a user, the animal waste collection cart comprising:
a bin holder having a round shape;
a handle assembly, comprising:
a handle grippable by the user, and
an adjustable pole to extend perpendicularly from the handle;
a main body, comprising:
a main pole configured to slidably couple to the adjustable pole,
a first auxiliary support pole disposed at a bottom portion of the main pole at a first end of the first auxiliary support pole and configured to extend outwardly away from the main pole,
a second auxiliary support pole disposed at the bottom portion of the main pole at a first end of the second auxiliary support pole and configured to extend outwardly away from the main pole,
a first curved pole connected to a second end of the first auxiliary support pole, such that a first end of the curved pole is connected to a first side of the bin holder,
a second curved pole connected to a second end of the second auxiliary support pole, such that a first end of the curved pole is connected to a second side of the bin holder;
an axle connected to a second end of the first curved pole at a first end of the axle, and connected to a second end of the second curved pole at a second end of the axle;
a first wheel disposed at the first end of the axle; and
a second wheel disposed at the second end of the axle.

2. The animal waste collection cart of claim 1, further comprising:
a bin configured to store animal waste therein and configured to be removably disposed within the bin holder.
